(19) United States
(12) Patent Application Publication
(10) Pub. No.: US 2009/0038120 A1
(43) Pub. Date: Feb. 12, 2009

(54) AUXILIARY HANDLE DEVICE

(76) Inventors: Roswitha Eicher, Filderstadt (DE); Stefan Heess, Leinfelden-Echterdingen (DE); Joerg Maute, Sindelfingen (DE); Florian Esenwein, Uhingen-Holzhausen (DE); Bernhard Eicher, Filderstadt (DE); Marcus Schuller, Dettenhausen (DE)

Correspondence Address: Striker, Striker & Stenby, 103 East Neck Road, Huntington, NY, 11743, US

(21) Appl. No.: 12/132,287

(22) Filed: Jun. 3, 2008

(30) Foreign Application Priority Data
Aug. 6, 2007 (DE) 102007037046.8

(51) Int. Cl. B25G 1/00; B23B 45/00

(52) U.S. Cl. 16/426; 173/170

(57) ABSTRACT

An auxiliary handle device, in particular for a hand-held power tool, has an auxiliary handle and a damping unit that includes a counter-oscillation unit with at least one oscillation element. The damping unit includes at least one joint unit, via which the oscillation element is supported in an oscillating manner.

### CROSS-REFERENCE TO A RELATED APPLICATION

The invention described and claimed hereinbelow is also described in German Patent Application DE 102007037046.8 filed on Aug. 6, 2007. This German Patent Application, subject matter of which is incorporated herein by reference, provides the basis for a claim of priority of invention under 35 U.S.C. 119(a)-(d).

### BACKGROUND OF THE INVENTION

The present invention is directed to an auxiliary handle device.

An auxiliary handle device for a hand-held power tool is already known, the auxiliary handle device including an auxiliary handle and a damping is unit. The damping unit includes a counter-oscillation unit with at least one oscillation element for generating a counter-oscillation.

### SUMMARY OF THE INVENTION

The present invention is directed to an auxiliary handle device, in particular for a hand-held power tool, with an auxiliary handle and a damping unit that includes a counter-oscillation unit with at least one oscillation element.

It is provided that the damping unit includes at least one joint unit, via which the oscillation element is supported.

In this context, an “auxiliary handle” is understood to be a region and/or a component and/or an element provided for placement—and enclosing, in particular—by one or two hands of an operator for guiding a hand-held power tool using an auxiliary handle device, and which is capable of being attached to the hand-held power tool in an auxiliary manner, adjacent to a further handle, in particular the main handle.

The auxiliary handle device is located on the side of the hand-held power tool, and/or is capable of being removed from the hand-held power tool by an operator without the use of tools, and/or is located in a front region of the hand-held power tool close to the tool, and/or the auxiliary handle is designed in the shape of a rod.

“Provided” is intended to mean, in particular, specially equipped and/or designed. A “joint unit” refers, in particular, to a unit that enables at least two components to be connected in a movable manner, with at least one component, in particular, being capable of pivoting, thereby changing its main extension relative to the other component. The joint unit may be, in particular, a flexible coupling, a turning-and-sliding pair, a cardan joint, and/or particularly preferably a ball joint. The inventive design provides an advantageous damping of the auxiliary handle—of the gripping region in particular—and, therefore, a high level of operating comfort for an operator. Support with a simple design coupled with mobility of the oscillation element relative to a further component, e.g., a grip sleeve, etc., may be attained.

During operation, vibrations are preferably damped via the generation of a counter-oscillation of the oscillation element that offsets an initial oscillation, the counter-oscillation absorbing the vibrational energy of the initial oscillation. The inventive auxiliary handle device is basically usable in conjunction with all hand-held power tools that appear reasonable to one skilled in the technical art, thereby making it easier, in particular, for an operator to guide hand-held power tools using the auxiliary handle. Due to its damping property, the auxiliary handle device is particularly advantageous when used with an angle grinder.

It is also provided that the auxiliary handle includes a grip sleeve that serves as a receiving area for receiving at least a portion of the counter-oscillation unit, thereby providing a receiving function with a simple design and making it possible to locate the counter-oscillation unit inside the auxiliary handle device in a particularly space-saving manner.

When the oscillation element is supported such that it may oscillate relative to the grip sleeve of the auxiliary handle, it is possible to at least partially decouple vibrations between the oscillation element and the grip sleeve.

When the auxiliary handle device includes a fastening unit for attachment to the hand-held power tool, the fastening unit being provided to transfer vibrations to the counter-oscillation unit, the counter-oscillation unit may be advantageously installed upstream of the auxiliary handle—or upstream of a grip sleeve of the auxiliary handle, in particular—in a vibration-damping manner, along a path of vibration transmission from the hand-held power tool to the auxiliary handle.

It is also provided that the joint unit is provided in order to transfer vibrations from the fastening unit to the oscillation element, thereby making it possible, advantageously, to utilize the vibration transmission to generate a counter-oscillation of the oscillation element and thereby dampen vibrations.

It is also provided that the damping unit includes at least one damping element that it at least partially enclosed by the joint unit, thereby making it possible to attain additional vibration damping in addition to a counter-oscillation generated by the oscillation element. In addition, vibrations of a grip sleeve of the auxiliary handle may be advantageously decoupled from the oscillation unit in particular when the damping element and/or the joint unit are/is provided as part of the oscillation element with the grip sleeve. The damping element is preferably composed of an elastomer and/or further damping elements that appear reasonable to one skilled in the technical art.

Particularly advantageously, the oscillation element is formed at least partially by an absorber mass element, thereby making it possible to advantageously increase a counter-oscillation that offsets an initial oscillation of the hand-held power tool, and to advantageously increase the inertia of the damping unit. In this context, an “absorber mass element” refers, in particular, to an element that is excited—at least within one intended frequency range of an initial oscillation and/or excitation oscillation—to generate a counter-oscillation that counteracts the initial or excitation oscillation, and therefore contributes to a reduction of vibrations.

When the absorber mass element is designed as a component that is cylindrical in at least one subregion, a particularly compact and space-saving counter-oscillation unit may be attained, since the joint unit and/or a vibration transmission to the absorber mass element may take place inside the absorber mass element, as is the case with a hollow cylindrical design in particular.

The absorber mass element may also have an increasing transverse extension along its longitudinal extension in a direction facing away from the joint unit, thereby making it advantageously possible to increase a moment of inertia of the absorber mass element to generate a counter-oscillation, in particular when a subregion with a maximum transverse extension of the absorber mass element is located a maximum distance away from the joint unit and/or an axis of oscillation. The absorber mass element is preferably designed in the shape of a lobe. Any other design of the absorber mass element that increases inertia and appears reasonable to one skilled in the technical art is also feasible.

It is also provided that the counter-oscillation element includes a membrane that encloses the absorber mass element, thereby making it possible to advantageously protect the absorber mass element during operation. In this context, a “membrane” refers, in particular, to a separating membrane that is provided to separate the absorber mass element from a region surrounding the absorber mass element, in particular when the absorber mass element at least partially includes a fluid and/or a volatile substance.

When the absorber mass element includes a fluid-permeable element and/or a damping fluid, it is therefore advantageously possible to attain vibration damping and a counter-oscillation based on the principle of a shock absorber. A “fluid-permeable” element refers, in particular, to an element that is preferably formed by a solid body with cavities, thereby making the solid body permeable to gases and/or fluids, e.g., a solid body with bores and/or, particularly advantageously, a porous solid body. The damping fluid is advantageously a pure fluid, a suspension, and/or further damping fluids that appear reasonable to one skilled in the technical art.

It is also provided that the damping unit includes at least one adjusting element that is provided for adjusting at least one oscillation parameter of the counter-oscillation unit, thereby making it possible to advantageously adapt the counter-oscillation unit to different oscillation behaviors of the hand-held power tool, in particular when working on different materials and/or when varying the operating modes of the hand-held power tool.

Further advantages result from the description of the drawing, below. Exemplary embodiments of the present invention are shown in the drawing. The drawing, the description, and the claims contain numerous features in combination. One skilled in the art will also advantageously consider the features individually and combine them to form further reasonable combinations.

### BRIEF DESCRIPTION OF THE DRAWINGS

FIG. 1 shows a hand-held power tool with an inventive auxiliary handle device, in a schematic depiction,

FIGS. 2a, 2b show the auxiliary handle device with a damping unit, which includes a bell-shaped oscillation element, in a sectional view,

FIG. 3 shows the auxiliary handle device with a damping unit that includes a cylindrical oscillation element, in a sectional view,

FIG. 4 shows the auxiliary handle device with a damping unit that includes a lobe-shaped oscillation element, in a sectional view, and

FIG. 5 shows the auxiliary handle device with a damping unit that includes an oscillation element with a membrane, in a sectional view.

### DESCRIPTION OF THE PREFERRED EMBODIMENTS

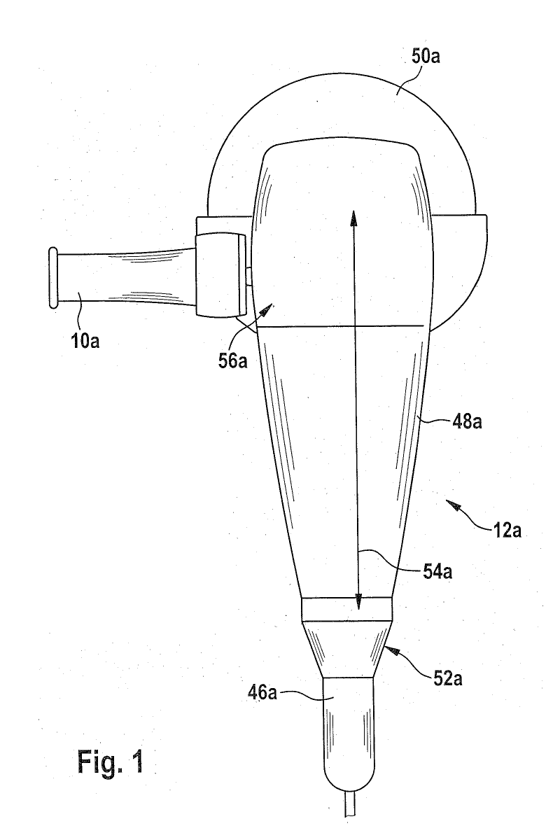

A hand-held power tool 12a designed as an angle grinder is shown in FIG. 1, in a perspective view from above. The angle grinder includes a housing 48a and a main handle 46a integrated in housing 48a. Main handle 46a extends along a side 52a facing away from a tool 50a that is a cutting disk, in a longitudinal direction 54a of the angle grinder. An auxiliary handle device 10a is located in a front region 56a of the angle grinder that is close to the tool, and extends transversely to longitudinal direction 54a of the angle grinder.

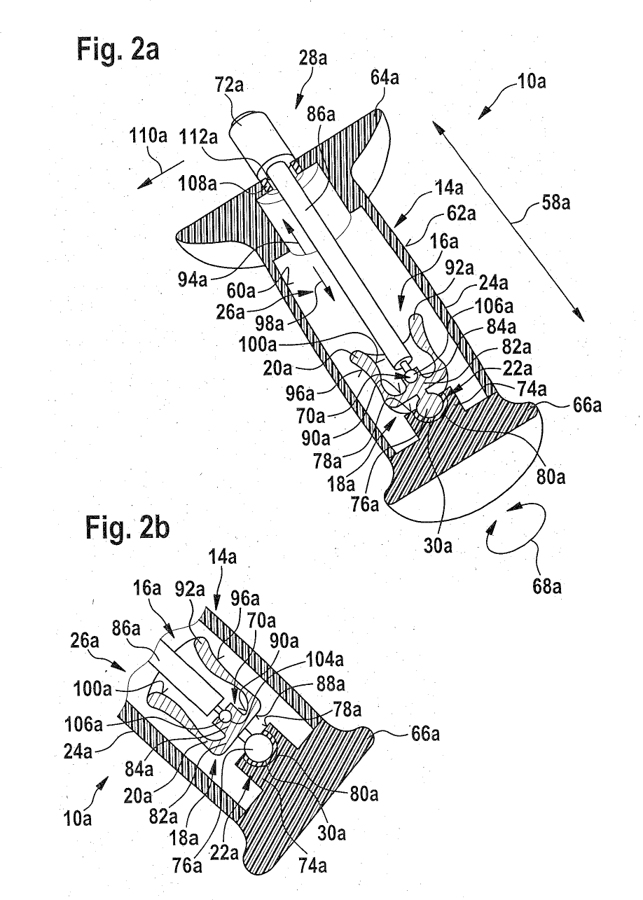

FIGS. 2a and 2b show auxiliary handle device 10a with an auxiliary handle 14a, a fastening unit 28a, and a damping unit 16a. Additional handle 14a includes a grip sleeve 24a, which extends along a main extension direction 58a of auxiliary handle device 10a. Grip sleeve 24a forms—together with a radially inwardly facing surface 60a—a receiving area 26a, which is provided to receive damping unit 16a. Receiving area 26a is designed cylindrical in shape along main extension direction 58a. Auxiliary handle 14a and/or grip sleeve 24a have/has a surface 62a that is curved radially outwardly along main extension direction 58a, thereby providing a particulary good grip for an operator of auxiliary handle device 10a.

A ridge-type raised area is located along main extension direction 58a in end regions 64a, 66a of grip sleeve 24a. The two ridge-type raised areas are located on auxiliary handle 14a in the manner of rings, in a circumferential direction 68a, which extends perpendicularly to main extension direction 58a. The two ridge-type raised areas extend radially outwardly from auxiliary handle 14a. During operation of auxiliary handle device 10a, ridge-type raised areas prevent the operator's hand from slipping when the operator guides hand-held power tool 12a using auxiliary handle device 10a and/or while force is being transmitted by the operator via auxiliary handle device 10a to hand-held power tool 12a.

Damping unit 16a includes a counter-oscillation unit 18a with an oscillation element 20a and two joint units 22a, 70a, each of which is designed as a ball joint. Joint units 22a, 70a connect and/or couple counter-oscillation unit 18a with a transmission element 86a that is designed as a single piece with a fastening element 72a of fastening unit 28a, and/or joint units 22a, 70a support oscillation element 20a at end region 66a of auxiliary handle 14a facing away from fastening unit 28a. To this end, first joint unit 22a includes a receiving element 74a in end region 66a, and a coupling element 76a of oscillation element 20a. Receiving element 74a extends in the manner of a cylinder into receiving region 26a and includes a capsule-like, spherical recess 80a on a side 78a facing fastening unit 28a. Spherical coupling element 76a of oscillation element 20a is supported in recess 80a. Oscillation element 20a is supported via coupling element 76a and receiving element 74a of end region 66a in a manner that allows it to oscillate relative to auxiliary handle 14a and/or grip sleeve 24a. In addition, to prevent a direct and undesired transmission of vibrations from oscillation element 20a to end region 66a, joint unit 22a includes a damping element 30a that is located between recess 80a of end region 66a and coupling element 76a of oscillation element 20a. Damping means 30a are composed of an elastomer and form an even damping layer that is injection-molded into recess 80a.

Oscillation element 20a is designed as an absorber mass element and has a cylindrical shape with an opening in direction 94a toward fastening unit 28a. To this end, oscillation element 20a includes a base region 82a, on which coupling element 76a is located, for coupling with or supporting end region 66a, and on which a further coupling element 84a is located, coupling element 84a being provided for coupling with transmission element 86a. The two coupling elements 76a, 84a are located on opposite surfaces 88a, 90a of base region 82a of oscillation element 20a. Oscillation element 20a also includes a jacket region 92a, which extends from base region 82a in a direction 94a toward fastening unit 28a. On a radially outwardly directed surface 96a, jacket region 92a has a shape that is concave in axial direction 94a, 98a and extends radially outwardly. On a radially inwardly directed surface 100a, jacket region 92a has a shape that is convex, extends radially inwardly, and becomes thicker in a direction 94a facing fastening unit 28a. A high moment of inertia is advantageously attained while a counter-oscillation is being produced, thereby resulting in advantageous absorption of vibrations via counter-oscillation unit 18a.

Second joint unit 70a includes coupling element 84a of oscillation element 20a, which extends along surface 90a—which faces fastening unit 28a—of base region 82a of oscillation element 20a in direction 94a toward fastening unit 28a. Coupling element 84a is cylindrical in design and includes a capsule-like, spherical recess 104a on a surface facing fastening unit 28a. A spherical coupling element 106 of transmission element 86a is located in recess 104, spherical coupling element 106 being designed as a single piece with transmission element 86a. Transmission element 86a has—in a region facing coupling element 106a—a smaller transverse extension than a transverse extension in a central subregion and a transverse extension of coupling element 106a, thereby enabling an oscillation of oscillation element 20a to take place with a large radius of oscillation.

Transmission element 86a extends along axial direction 94a, 98a from fastening unit 28a to oscillation element 20a and transfers a vibration during operation of hand-held power tool 12a via fastening unit 28a and/or fastening element 72a of fastening unit 28a to oscillation element 20a. Fastening element 72a is designed in the shape of a bolt, and it is provided to be screwed together with hand-held power tool 12a. In addition, fastening element 72a has a greater transverse extension than a transverse extension of transmission element 86a. A further transmission element 108a of damping unit 16a is located between transmission element 86a and end region 64a to prevent a direct transmission of vibrations from fastening element 72a and/or transmission element 86a to auxiliary handle 14a and/or end region 64a of auxiliary handle 14a facing fastening unit 28a.

Damping element 108a is composed of an elastomer and is integrally extruded with end region 64a of auxiliary handle 14a, damping element 108a being located at a distance from transmission element 86a, thereby enabling fastening unit 28a and transmission element 86a to oscillate relative to auxiliary handle 14a and/or grip sleeve 24a during operation. To this end, end region 64a has an opening 112a located in the center in radial direction 110a, through which transmission element 86a is guided.

During operation of hand-held power tool 12a, a vibration of hand-held power tool 12a is transferred via fastening unit 28a to transmission element 86a, and from transmission element 86a via joint unit 22a, to counter-oscillation unit 18a. Oscillation element 20a is excited to produce an oscillation that, due to the support of oscillation element 20a via the two joint units 22a, 70a, offsets the initial oscillation of hand-held power tool 12a.

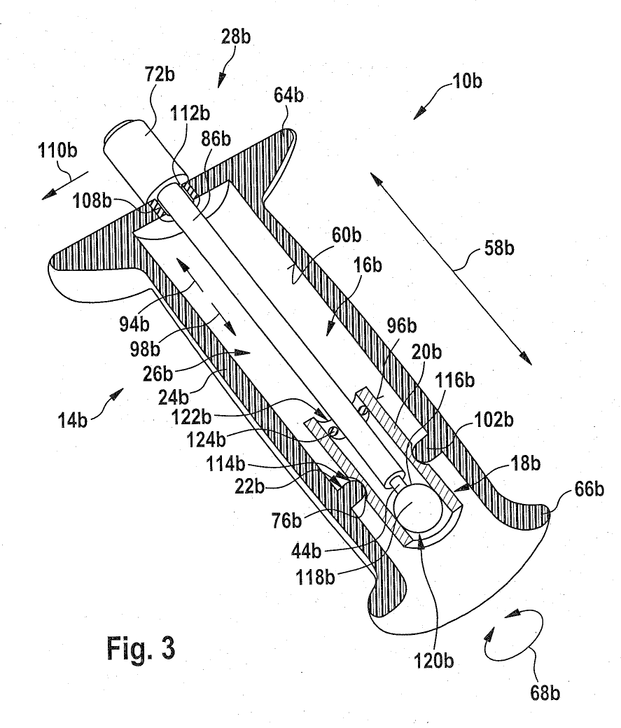

Alternative exemplary embodiments are shown in FIGS. 3 through 5. Components, features, and functions that are essentially the same are labelled with the same reference numerals. To distinguish the exemplary embodiments from each other, the reference numerals of the exemplary embodiments are appended with the letters a through d. The description below is essentially limited to the differences from the exemplary embodiment in FIGS. 1 through 2b. With regard for the components, features, and functions that remain the same, reference is made to the description of the exemplary embodiment in FIGS. 1 through 2b.

FIG. 3 shows an alternative auxiliary handle device 10b with a damping unit 16b. Damping unit 16b includes a counter-oscillation unit 18b with an oscillation element 20b designed as an absorber mass element. Oscillation element 20b, which is designed as a sleeve, is supported via a joint unit 22b such that it may oscillate relative to a grip sleeve 24b of an auxiliary handle 14b. To this end, joint unit 22b includes two coupling elements 76b, 102b. First coupling element 102b of grip sleeve 24b is located in a circumferential direction 68b on a radially inwardly oriented surface 60b of grip sleeve 24b, and it is designed as a peg-shaped ring.

In addition, coupling element 102b may be designed at least partially as a damping element, to prevent direct transmission of vibrations from oscillation element 20b to grip sleeve 24b. Oscillation element 20b includes second coupling element 76b, which is designed as an annular groove in a radially outwardly oriented surface 96b in circumferential direction 68b located in a central subregion 114b relative to axial direction 94b, 98b. Vibrations are transferred to oscillation element 20b during operation of hand-held power tool 12b via a fastening element 72b of a fastening unit 28b and via a transmission element 86b.

On an end 116b facing away from fastening unit 28b, transmission element 86b is guided inside sleeve-shaped and/or cylindrical oscillation element 120b, and it includes a spherical oscillating weight 118b and an adjusting element 44b on end 1 16b. In order to transfer vibrations using transmission element 86b to oscillation element 20b to generate a counter-oscillation, oscillating weight 118b has a diameter that is equal to an inner diameter of oscillating element 20b. Using adjusting element 44b, an operator of auxiliary handle device 10b may adjust a distance between oscillating weight 118b and end 116b of transmission element 86b and, therefore, an amplitude of a counter-oscillation of oscillation element 20b.

Oscillating weight 118b is supported in a region 120b of oscillation element 20b facing away from fastening unit 28b, so that, when vibrations are transferred, a region 122b of oscillation element 20b facing fastening unit 28b performs an oscillating motion—via joint unit 22b—that is oriented opposite to that being performed by oscillating weight 118b. An axis of oscillation about which a counter-oscillation of oscillation element 20b takes place is located within a plane defined by first coupling element 102b. A damping element 124b designed as an elastomer ring is integrally extruded with oscillation element 20b in a region 122b of oscillation element 20b facing fastening unit 28b.

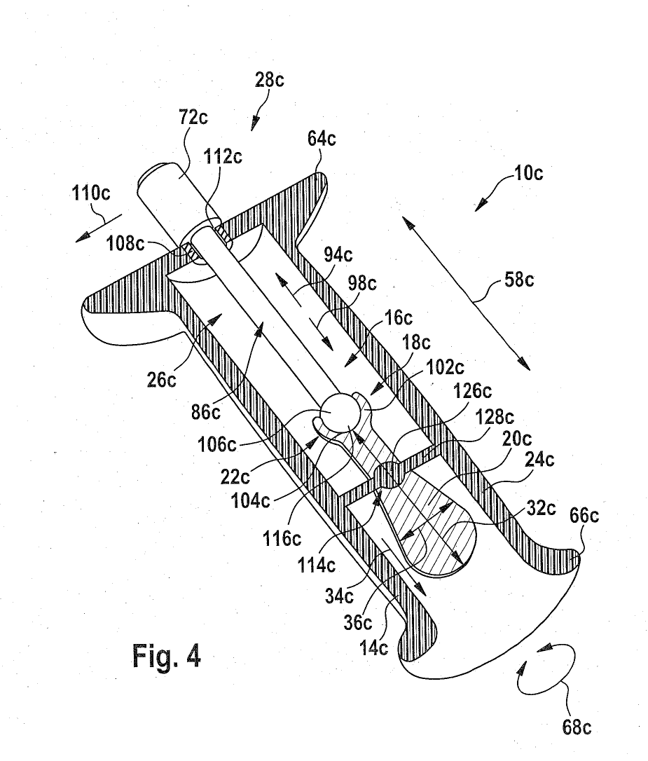

FIG. 4 shows an alternative auxiliary handle device 10c with a damping unit 16c. Damping unit 16c includes a counter-oscillation unit 18c with an oscillation element 20c designed as an absorber mass element, which is coupled with a transmission element 86c for the purpose of generating a counter-oscillation using a joint unit 22c designed as a ball joint. To this end, transmission element 86c includes a spherical coupling element 106c on an end 116c facing oscillation element 20c, the transmission element 86c and oscillation element 20c being located one after the other within a receiving region 26c of an auxiliary handle 14c along an axial direction 94c, 98c. Coupling element 106c is supported in a recess 104c of a coupling element 102c of oscillation element 20c. Oscillation element 20c is also supported relative to a grip sleeve 24c in a central subregion 114c in axial direction 94c, 98c using a bearing element 126c. To this end, grip sleeve 24c includes an element 128c designed in the manner of a ladder rung and located on radially opposite sides of grip sleeve 24c.

Element 128c includes bearing element 126c in a central subregion, in radial direction 110c of element 128c, to support oscillation element 20c in an oscillating manner, an axis of oscillation of oscillation element 20c being oriented perpendicularly to the plane of the drawing. To further prevent a potential transmission of vibrations from oscillation element 20c to grip sleeve 24c, it is basically feasible for bearing element 126c to be designed as a damping element. Oscillation element 20c has a lobe-shaped design along its longitudinal extension 32c, with a transverse extension 36c that increases in a direction 34c facing away from joint unit 22c, thereby resulting in effective vibration damping with a high moment of inertia during operation.

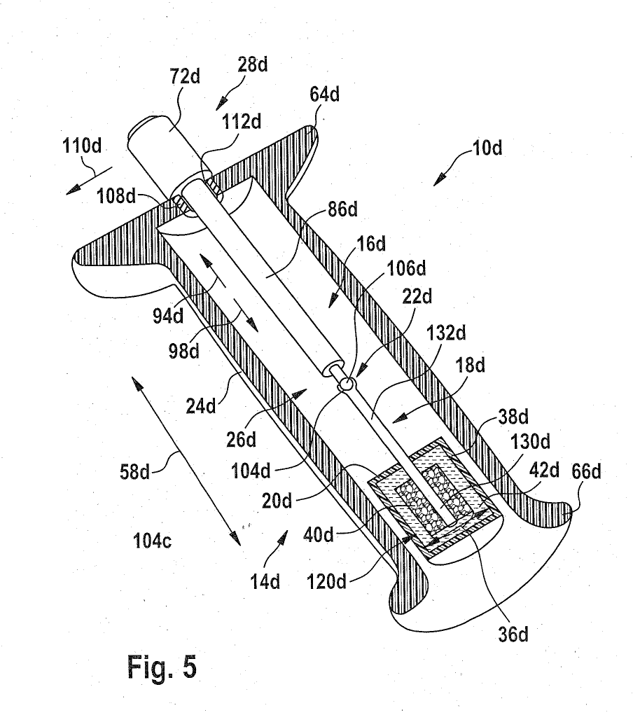

FIG. 5 shows an alternative auxiliary handle device 10d with a damping unit 16d. Damping unit 16d includes a counter-oscillation unit 18d with an oscillation element 20d, which is coupled with a transmission element 86d for the purpose of generating a counter-oscillation using a joint unit 22d designed as a ball joint. Joint unit 22d is designed as described with reference to the designs shown in FIG. 4, so it will not be described in greater detail here. Oscillation element 20d includes an absorber mass element with a damping fluid 42d and a fluid-permeable, porous element 40d in a region 120d facing away from transmission element 86d. To this end, oscillation element 20d includes a membrane 38d that encloses the absorber mass element and prevents damping fluid 42d from escaping.

Membrane 38d may also be bent when acted upon by strong oscillations, e.g., when it strikes a grip sleeve 24d. Membrane 38d therefore serves to protect the absorber mass element. Vibrations are damped using the absorber mass element in a manner based on the principle of a shock absorber. Porous element 40d is located on an end 130d of a lever arm 132d of oscillation element 20d facing away from joint unit 22d, lever arm 132d connecting the absorber mass element with joint unit 22d. When hand-held power tool 12d is operated with auxiliary handle device 10d, an oscillatory motion is transmitted to oscillation element 20d from hand-held power tool 12d via a fastening unit 28d and transmission element 86d.

Porous element 40d, which is coupled with a motion of transmission element 86d via lever arm 132d, performs an oscillatory motion with a slight time delay after transmission element 86d. The oscillatory motion of porous element 40d induces a counter-motion of damping fluid 42d, which flows past and through porous element 40d, thereby enhancing the absorption of vibrations. Absorber mass element has a greater transverse extension 36d than a transverse extension of lever arm 132d, thereby resulting—particularly advantageously—in a high moment of inertia for a counter-oscillation and/or vibration damping.

It will be understood that each of the elements described above, or two or more together, may also find a useful application in other types of a constructions differing from the type described above.

While the invention has been illustrated and described as embodied in an auxiliary handle device, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An auxiliary handle device, comprising an auxiliary handle; and a damping unit which includes a counter-oscillation unit with at least one oscillation element, said damping unit including at least one joint unit, via which said oscillation element is supported in an oscillating manner.

2. An auxiliary handle device as defined in claim 1, wherein said auxiliary handle includes a grip sleeve configured as a receiving area for receiving at least a portion of said counter-oscillation unit.

3. An auxiliary handle device as defined in claim 2, wherein said oscillating element is supported in an oscillating manner relative to said grip sleeve of said auxiliary handle; further comprising means for supporting said oscillating element in the oscillating manner relative to said grip sleeve.

4. An auxiliary handle device as defined in claim 1; further comprising a fastening unit for attachment to the hand-held power tool, said fastening unit being configured to transfer vibrations to said counter-oscillation unit.

5. An auxiliary handle device as defined in claim 4, wherein said joint unit is configured to transmit vibrations from said fastening unit to said oscillation element.

6. An auxiliary handle device as defined in claim 1, wherein said damping unit includes at least one damping element which is at least partially enclosed by said joint unit.

7. An auxiliary handle device as defined in claim 1, wherein said damping element is composed of an elastomer.

8. An auxiliary handle device as defined in claim 1, wherein said oscillating element is formed at least partially by an absorber mass element.

9. An auxiliary handle device as defined in claim 8, wherein said absorber mass element is configured as a component that is cylindrical in at least one subregion.

10. An auxiliary handle device as defined in claim 8, wherein said absorber mass element has an increasing transverse extension along its longitudinal extension in a direction facing away from said joint unit.

11. An auxiliary handle device as defined in claim 8, wherein said counter-oscillation unit includes a membrane that encloses said absorber mass element.

12. An auxiliary handle device as defined in claim 8, wherein said absorber mass element includes a fluid-permeable element.

13. An auxiliary handle device as defined in claim 8, wherein said absorber mass element is configured as an element including a damping fluid.

14. An auxiliary handle device as defined in claim 1, wherein said damping unit includes at least one adjusting element for adjusting at least one oscillation parameter of said counter-oscillation unit.

15. A hand-held power tool, comprising a main handle; and an auxiliary handle device, said auxiliary handle device including an auxiliary handle, and a damping unit which includes a counter-oscillation unit with at least one oscillation element, said damping unit including at least one joint unit, via which said oscillation element is supported in an oscillating manner.

16. A hand-held power tool as defined in claim 15, wherein the hand-held power tool is configured as an angle grinder.
